(19) United States
(12) Patent Application Publication
(10) Pub. No.: US 2014/0267204 A1
(43) Pub. Date: Sep. 18, 2014

(54) SYSTEM AND METHOD FOR CALIBRATING LINE TIMES

(71) Applicant: QUALCOMM MEMS Technologies, Inc., San Diego, CA (US)

(72) Inventors: Hemang Shah, San Diego, CA (US); Mark M. Todorovich, San Diego, CA (US)

(21) Appl. No.: 13/828,207

(22) Filed: Mar. 14, 2013

(51) Int. Cl. G09G 3/34; G09G 3/20

(52) U.S. Cl. CPC G09G 3/3466; G09G 3/20
USPC 345/208; 345/204

(57) ABSTRACT

This disclosure provides systems, methods and apparatus, including computer programs encoded on computer storage media, for adjusting the waveform timing parameters for changes in data to be written over the lifetime of the display. In one aspect, timing parameter information is stored with the array and used to obtain the fastest line timing possible for different portions of the array. The timing parameter information may also be updated over the lifetime of the display such that the fastest line timing possible for different portions can be obtained over the life of the display.

### TECHNICAL FIELD

This disclosure relates to dynamic selection of line timing parameters in electromechanical systems and devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus for driving a display including a plurality of common lines and a plurality of segment lines connected to an array of display elements. The apparatus may include a controller configured to receive, as part of a frame of image data to be written to the array of display elements, image data for one or more common lines of the array, wherein the controller is configured to determine one or more waveform timing parameters for writing at least some of the image data to display elements along at least a first one of the one or more common lines of the array. The apparatus may further include a memory storing information correlating different line speed classifications with different portions of the array of display elements. The determining is based at least in part on the stored speed classification of the portion of the array containing the one or more common lines and one or more of the write actuation state to be produced in the display elements along at least the first one of the one or more common lines as defined by the at least some of the image data, and characteristics of at least some of the segment line transitions that will occur to place the segment lines in a series of states operable to write the image data to the one or more common lines. The apparatus further includes a common driver and a segment driver configured to drive the array of display elements to write the at least some of the image data to display elements along the at least first one of the one or more common lines with the determined one or more waveform timing parameters.

Another innovative aspect of the subject matter described in this disclosure can be implemented in a method of driving an array of display elements comprises storing speed classifications for different portions of the array of display elements in memory, and writing electronic signals to the different portions of the array of display elements based at least in part on the speed classifications.

Another innovative aspect of the subject matter described in this disclosure can be implemented in an apparatus for driving a display including a plurality of common lines and a plurality of segment lines connected to an array of display elements. The apparatus includes a memory storing information correlating different line speed classifications to different portions of the array of display elements, and means for writing electronic signals to the different portions of the array of display elements based at least in part on the speed classification of the portion of the array.

Another innovative aspect of the subject matter described in this disclosure can be implemented in a non-transitory computer readable media having instructions stored thereon that cause a processing circuit to perform a method of driving an array of display elements. The method includes storing speed classifications for different portions of an array of display elements in memory, and writing electronic signals to the different portions of the array of display elements based at least in part on the speed classifications.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a graph illustrating movable reflective layer position versus applied voltage for an IMOD display element.

FIG. 4 is a table illustrating various states of an IMOD display element when various common and segment voltages are applied.

FIG. 5A is an illustration of a frame of display data in a three element by three element array of IMOD display elements displaying an image.

FIG. 5B is a timing diagram for common and segment signals that may be used to write data to the display elements illustrated in FIG. 5A.

FIGS. 6A and 6B are schematic exploded partial perspective views of a portion of an electromechanical systems (EMS) package including an array of EMS elements and a backplate.

FIG. 7 shows an example of a timing diagram for common line and segment line driving signals that may be used to write display data.

FIG. 8 is an example schematic diagram of an implementation of a display array with state sensing and drive scheme voltage update capabilities.

FIG. 9 shows an example of a timing diagram for common line and segment line driving signals that may be used to write display data.

FIG. 10 is an example schematic diagram of an implementation of a display array with state sensing and drive scheme voltage update capabilities and adaptive line time tables.

FIG. 11 shows an example of a flow diagram illustrating a method of driving an array of display elements.

FIGS. 12A and 12B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

When writing data to a MEMS display, a write waveform is sequentially applied to the common lines of the display array during a series of “line times.” This write waveform has several parameters, including voltage amplitudes at various times during the line time as well as time durations of the various components of the waveform during the line time. The appropriate values for these components may be different from array to array, or within portions of a single array. Furthermore, the appropriate values for these components may change over time and with the ambient temperature in which the array is operating. As such, the timing parameters that can be used may vary on an array by array basis, or even a line by line basis, and may also be dependent on display use and may further vary over the lifetime of the display. To compensate for this, additional line timing information can be stored for the array and may further be updated over the lifetime of the display in order to use the fastest line timing possible for different portions of the array over the life of the display.

Particular implementations of the subject matter described in this disclosure can be implemented to realize one or more of the following potential advantages. Variable write waveform line time can be implemented to reduce the time required to write display data when compared to drivers known in the art. This may increase the frame rate at which images are displayed, and reduce artifacts associated with lower frame rate. Further, the performance of display elements may be improved with the same overall update rate for the display. For a given target update rate, it can be useful to allocate line time duration differently for different lines of the display based on particular image data to be written to the display and the particular structure of the display elements along the line. This can provide more margin for suitable operation for the display elements, and as a result, the yield of the display panels can be improved without reducing frame rate or sacrificing image quality. Updating timing parameters over the life of a device may also allow for an optimally functioning display over the entire life of the display. In some implementations, optimal timing parameters can be determined without using excess memory or computing power.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

FIG. 3 is a graph illustrating movable reflective layer position versus applied voltage for an IMOD display element. For IMODs, the row/column (i.e., common/segment) write procedure may take advantage of a hysteresis property of the display elements as illustrated in FIG. 3. An IMOD display element may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3-7 volts, in the example of FIG. 3, exists where there is a window of applied voltage within which the element is stable in either the relaxed or actuated state. This is referred to herein as the “hysteresis window” or “stability window.” For a display array 30 having the hysteresis characteristics of FIG. 3, the row/column write procedure can be designed to address one or more rows at a time. Thus, in this example, during the addressing of a given row, display elements that are to be actuated in the addressed row can be exposed to a voltage difference of about 10 volts, and display elements that are to be relaxed can be exposed to a voltage difference of near zero volts. After addressing, the display elements can be exposed to a steady state or bias voltage difference of approximately 5 volts in this example, such that they remain in the previously strobed, or written, state. In this example, after being addressed, each display element sees a potential difference within the “stability window” of about 3-7 volts. This hysteresis property feature enables the IMOD display element design to remain stable in either an actuated or relaxed pre-existing state under the same applied voltage conditions. Since each IMOD display element, whether in the actuated or relaxed state, can serve as a capacitor formed by the fixed and moving reflective layers, this stable state can be held at a steady voltage within the hysteresis window without substantially consuming or losing power. Moreover, essentially little or no current flows into the display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each display element (that is, the potential difference across each display element or pixel) determines the resulting state of each display element. FIG. 4 is a table illustrating various states of an IMOD display element when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

As illustrated in FIG. 4, when a release voltage VC_{REL} is applied along a common line, all IMOD display elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator display elements or pixels (alternatively referred to as a display element or pixel voltage) can be within the relaxation window (see FIG. 3, also referred to as a release window) both when the high segment voltage VS_{H} and the low segment voltage VS_{L} are applied along the corresponding segment line for that display element.

When a hold voltage is applied on a common line, such as a high hold voltage VC_{HOLD}_{_{—}}_{H} or a low hold voltage VC_{HOLD}_{_{—}}_{L}, the state of the IMOD display element along that common line will remain constant. For example, a relaxed IMOD display element will remain in a relaxed position, and an actuated IMOD display element will remain in an actuated position. The hold voltages can be selected such that the display element voltage will remain within a stability window both when the high segment voltage VS_{H} and the low segment voltage VS_{L} are applied along the corresponding segment line. Thus, the segment voltage swing in this example is the difference between the high VS_{H} and low segment voltage VS_{L}, and is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that common line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having substantially no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation that could occur after repeated write operations of a single polarity.

FIG. 5A is an illustration of a frame of display data in a three element by three element array of IMOD display elements displaying an image. FIG. 5B is a timing diagram for common and segment signals that may be used to write data to the display elements illustrated in FIG. 5A. The actuated IMOD display elements in FIG. 5A, shown by darkened checkered patterns, are in a dark-state, i.e., where a substantial portion of the reflected light is outside of the visible spectrum so as to result in a dark appearance to, for example, a viewer. Each of the unactuated IMOD display elements reflect a color corresponding to their interferometric cavity gap heights. Prior to writing the frame illustrated in FIG. 5A, the display elements can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. In some implementations, the segment voltages applied along segment lines 1, 2 and 3 will have no effect on the state of the IMOD display elements, as none of common lines 1, 2 or 3 are being exposed to voltage levels causing actuation during line time 60a (i.e., VC_{REL}−relax and VC_{HOLD}_{_{—}}_{L}−stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the display element voltage across modulators (1,1) and (1,2) is greater than the high end of the positive stability window (i.e., the voltage differential exceeded a characteristic threshold) of the modulators, and the modulators (1,1) and (1,2) are actuated. Conversely, because a high segment voltage 62 is applied along segment line 3, the display element voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the display element voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state. Then, the voltage on common line 2 transitions back to the low hold voltage 76.

Finally, during the fifth line time 60e, the voltage on common line 1 remains at high hold voltage 72, and the voltage on common line 2 remains at the low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 display element array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the display element voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5A. In some other implementations, voltages applied along common lines or segment lines may vary to account for variations in the actuation and release voltages of different modulators, such as modulators of different colors.

FIGS. 6A and 6B are schematic exploded partial perspective views of a portion of an EMS package 91 including an array 36 of EMS elements and a backplate 92. FIG. 6A is shown with two corners of the backplate 92 cut away to better illustrate certain portions of the backplate 92, while FIG. 6B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 6A and 6B, the backplate 92 can include one or more backplate components 94a and 94b, which can be partially or wholly embedded in the backplate 92. As can be seen in FIG. 6A, backplate component 94a is embedded in the backplate 92. As can be seen in FIGS. 6A and 6B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 6B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 6A and 6B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 6A and 6B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

Data may be written to a display through variation of a common line driving signal and a segment line driving signal. FIG. 7 shows an example of a timing diagram for common line and segment line driving signals that may be used to write display data. FIG. 7 includes three positive common line write waveforms (Common Line 1, Common Line 2, and Common Line 3). Also illustrated are three segment line waveforms (Segment Line 1, Segment Line 2, and Segment Line 3). A person having ordinary skill in the art will recognize that the number of common lines and segment lines configured to drive the array of display elements is based on the type of display, and/or the driving scheme used for driving the display.

As illustrated in FIG. 7, each display element in the array may initially be driven to a non-actuated state by application of a clearing pulse having a release voltage 70. Following the clearing pulse, a common line may be transitioned to a hold voltage level, for example a high hold voltage 72 as illustrated in FIG. 7. To write data to a line of display elements, the common line is transitioned from the high hold voltage 72 to a high address voltage 74 and back to the high hold voltage 72. There are three time periods during the process to write data, referred to herein as the front porch (FP), write pulse (WP), and back porch (BP) as illustrated in FIG. 7 and discussed further below with reference to FIG. 9, which may collectively be referred to as a line time 60.

The actuation voltages and release voltages may be different for different interferometric modulators in an array. In addition, the actuation voltages and release voltages can change with variations in temperature, aging, and use patterns of the display over its lifetime. This can make it useful for optimal display operation to vary the voltages used in a drive scheme in a manner that tracks these changes during use and over the life of the display array.

FIG. 8 is an example schematic diagram of an implementation of a display array with state sensing and drive scheme voltage update capabilities. In FIG. 8, the display array is shown as two separate arrays, an upper array 810 and a lower array 812. The segment lines of the two arrays are driven with two segment drivers 814 and 816 respectively.

The common lines are driven with a common driver circuit 818. A processor/controller 820 controls the driver circuits as well as a series of switches 842 and an integrator 850 which functions to measure the response voltages of the display elements in different lines of the array. The processor/controller 820 has access to a look up table 824 (which may be in a memory internal to or external to the integrated circuit of the processor/controller 820). Because changes in temperature are a significant factor in changes in drive response characteristics (and thus suitable drive scheme voltages), the look up table 824 stores information relating drive response characteristics or drive scheme voltages with temperature. This information may be initially obtained from testing of the display array during manufacture and/or known relationships between drive response characteristics and temperature. This implementation also includes a temperature sensor 822 located on or near the display array. The look up table 824 may contain values related to actuation and release voltages for each color display element for a series of temperatures or temperature ranges. In some implementations, the processor/controller 820 takes the temperature value from the temperature sensor 822, retrieves the appropriate values from the look up table 824, calculates hold voltages for each color and a segment voltage from these retrieved values, and controls the common driver circuit 818 and the segment drivers 814 and 816 to use the computed drive scheme voltages when writing image data to the display. As the temperature changes, the processor/controller 820 may select different drive scheme voltages according to the data in the look up table 824, even without additional testing of the display array during use.

Although this can help maintain the drive scheme voltages closer to their desired values, the data in the look up table 824 may contain some inaccurate values, and in addition, the actual values for actuation and release voltages for the display array as a function of temperature may change over time. To account for this, the system of FIG. 8 may be configured to periodically update the data in the look up table 824 using measured values for the actuation and release voltages obtained during use of the array. The integrator 850 and switches 842 are used to make these measurements periodically over the life of the display.

FIG. 9 shows an example of a timing diagram for common line and segment line driving signals that may be used to write display data. In addition to the voltage amplitude parameters of the write waveforms such as the hold voltages 72, write voltages 74, and segment voltages 62 and 64, the waveforms also have timing parameters. For the common line waveform, a line time 60 includes a front porch 1020, a write pulse 1024, and a back porch 1022. A front porch 1020 may be defined as a delay time following initiation of segment line transitions and before the write pulse 1024 in order to avoid error in writing data to a display element along the common line. During a write pulse 1024, a voltage level corresponding to an address voltage, for example a high address voltage 74, is applied. A back porch 1022 may be defined as a delay time following the write pulse 1024 and prior to initiation of segment line transitions in order to avoid error in writing data to a display element connected to the common line. The front porch 1020 and back porch 1022 may compensate for a delay during a transition between an address voltage, such as high address voltage 74, and a hold voltage, such as high hold voltage 72.

The segment transitions include a low segment voltage 64 and a high segment voltage 62 such that, for a positive polarity write waveform, the display element is actuated when a write pulse 1024 of a high address voltage 74 is applied and the corresponding segment line is at a low segment voltage 64. The front porch 1020 and back porch 1022 may be provided to introduce delays between the segment transitions and the edges of the write pulse. The delays may be useful because of waveform distortions of the common line potentials during segment transitions due to capacitance coupling of the components of the circuit, or the like.

In the example illustrated in FIG. 9, a positive polarity is assumed for driving the display such that the front porch 1020 and back porch 1022 correspond to a high hold voltage 72 and the write pulse 1024 corresponds to a high address voltage 74. The waveform may also have a negative polarity. For a negative polarity waveform, a front porch 1020 and back porch 1022 correspond to a low hold voltage 76, and the write pulse 1024 corresponds to a low address voltage 78.

Table 1 below shows examples of a front porch 1020 duration, a write pulse 1024 duration, and a back porch 1022 duration corresponding to different frame rates in one implementation for driving a display having 1,152 common lines.

TABLE 1
Example Frame Rates and Timing

| Frame | Front | Write | Back | Total Line |
|---|---|---|---|---|
| Rate | Porch (μs) | Pulse (μs) | Porch (μs) | Time (μs) |
| 15 Hz | 8 | 40 | 8 | 56 |
| 6.7 Hz | 12 | 70 | 47 | 129 |

As shown in Table 1, for a frame rate of 15 Hz, a front porch 1020 may be set to 8 μs, a write pulse 1024 may be set to 40 μs, and a back porch 1022 may be set to 8 μs for a total line time 60 of 56 μs. Alternatively, for a frame rate of 6.7 Hz, a front porch 1020 may be set to 12 μs, a write pulse 1024 may be set to 70 μs and a back porch 1022 may be set to 47 μs for a total line time 960 of 129 μs.

A front porch 1020 may be set to provide sufficient time for all segment lines to settle to their new state following a segment line transition prior to the application of the write pulse 1024. Similarly, a back porch 1022 may be provided such that a write pulse 1024 may settle to a hold state prior to a subsequent segment line transition. The duration of the write pulse 1024 provides sufficient time to enable actuation of the display element on segment lines which are to be actuated by the write pulse 1024.

For example, in driving an array of display elements having a plurality of common lines and a plurality of intersecting segment lines connected to the display elements, the segment line transitions along a common line in the array may be staggered to reduce cross-talk in writing data to the display. Cross-talk may occur when a large number of segment lines are transitioned in phase at the start of a new line time. When segments are switching from −Vs to +Vs (or from +Vs to −Vs) due to the fact that the segment lines are being switched to write data to a new line, which in general is different data than that written to the previous line, a sudden change in the amount of charge on the segment lines is produced. This may cause a voltage transient on the common lines, leading to a potentially undesirable voltage levels along one or more common electrodes. As a result, display elements that were previously actuated may be released in error due to the cross talk of the transitioning segment lines.

The duration of the write pulse 1024 may be set to provide adequate charge to write all display elements connected to the common line. A display element in an actuated position exhibits higher capacitance than a display element in an un-actuated state. As discussed above with reference to FIG. 9, a clearing pulse 70 may be applied to a common line prior to writing image data to display elements along the common line. The clearing pulse 70 is configured to transition the display elements along the common line to an un-actuated or relaxed state prior to writing the image data. In writing the image data, a larger capacitance is connected to the drive lines when a first number of display element are transitioned from an un-actuated state to an actuated state compared to when a second number of display element are transitioned from un-actuated state to actuated if the second number of display element transitions is less than the first number of display element transitions. As a result, more charge must be sourced from the driver when more display elements are transitioned from an un-actuated state (for example, the state after the clear cycle 70) to an actuated state due to the larger capacitance. The duration of the write pulse 1024 according to a conventional technique is based on the assumption that potentially all display elements along a common line will be transitioned from an un-actuated state to an actuated state when writing a line of display elements.

The duration of the back porch may be selected to reduce or prevent accidental release of actuated display elements in a previously written line when the segments transition to the new data for the next line. This accidental release can occur if there is insufficient delay between the end of the write pulse for the previous line and the segment transitions that occur to write the immediately subsequent line. For example, with reference to FIG. 9, display elements along common line 1 may be accidentally released following the write pulse 74 if a segment line (for example, segment line 2) transitions very shortly after the write pulse 74 of common line 1. Since the display element corresponding to segment line 2 and common line 1 may not yet be fully mechanically stabilized to the actuated state immediately following the write pulse 74, the transition of the segment line 2 from the low segment voltage 64 to the high segment voltage 62 may cause the display element to accidentally release. Because the display elements are very sensitive to transient voltage swings immediately after being actuated, it has been found useful to maintain a period following the end of each write pulse 1024 where no segment transitions occur, not even the transitions of the first stagger group.

It may be further noted that the back porch is more important to proper display element operation for some common lines than for others in the display. In an array of display elements having a plurality of common lines intersecting a plurality of segment lines, different common lines are situated at different distances from the segment driver connected to the plurality of segment lines. As a result of the difference in distance from the segment driver, when the segment driver changes the state of a segment line, the transition is steepest at the common lines nearest the segment driver. Due to impedance along the segment line length, the rise time of the voltage is longer at the far end of the display away from the segment driver. As a result, the segment lines exhibit sharper and steeper transitions for display elements that are closer to the segment driver than for display elements that are farther from the segment driver. Due to the sharper transitions close to the segment driver, the segment line transitions produce larger transients on the common lines and may cause more accidental release of display elements that are closer to the segment driver that have transitioned to an actuated state relative to display elements that are farther from the segment driver. Therefore, a long back porch 1022 is more important for common lines that are closer to the segment driver, relative to common lines that are farther from the segment driver.

Conventionally, the same front porch 1020 duration, back porch 1022 duration, and write pulse duration 1024 are used for every common line across the array. In such implementations, the front porch 1020 used for every common line is the overall maximum front porch 1020 duration. Furthermore, the back porch 1022 duration used for every common line is the overall maximum back porch 1022 duration. In addition, the write pulse 1024 duration used is the overall maximum write pulse 1024 duration. The line time used for every common line in these conventional implementations is therefore max(FP)+max(WP)+max(BP).

As discussed above, the frame rate of the display is inversely proportional to the line time, such that as the line time increases, the frame rate decreases. Since the line time includes the combined time of a front porch 1020, back porch 1022, and write pulse 1024, a reduction in the front porch 1020, the back porch 1022, and/or the write pulse 1024 would result in a faster frame rate for the display.

According to some implementations, a line time duration (for example, sum of front porch 1020, back porch 1022, and/or write pulse 1024) may be adjusted based on data to be written to an array of display elements. Using this technique, display elements connected to common lines that can be written faster without errors due to the nature of the data being written are written faster, thus reducing the total time required to write a frame of data. Thus, a line time for writing image data to a common line connected to a line of display elements may be determined based on the image data to be written to the display elements. In some implementations, the image data is analyzed to determine the number of display elements that will be transitioned from an un-actuated to an actuated state, and the number of segment line transitions that will occur. In some implementations, other factors, such as the color of display elements, and the location of a common line in the array may also be used to determine the line times.

For example, since display elements which exhibit different colors have different mechanical characteristics, they may have different response times to the application of write pulse 1024 and require different minimum write pulse 1024 durations. Similarly, a suitable front porch 1020 and back porch 1022 for different color display elements may be dependent on the color of the display element. In some implementations, different color display element rows are driven with driving signals corresponding to different write waveform line times. The line times of each color display element row may be configured based on the characteristics of the specific color, and the corresponding physical structure and response time of the particular color display element.

For example, a line time for lines having only blue display elements in the array may be less than a line time for green display elements in the array. A row including green display elements may be configured with a longer line time than a row with red display elements. Similarly, the row of red display elements may be configured to have a longer line time than the row of blue display elements.

Further, in some implementations the line times may also be determined based on a position of the line of display elements relative to a segment driver. For example, since the segment transitions occur sooner for common lines closer to the segment driver, in some implementations, the back porch 1022 duration may be set to be relatively longer for common lines closer to the segment driver.

FIG. 10 is an example schematic diagram of an implementation of a display array with state sensing and drive scheme voltage update capabilities and adaptive line time tables. In some implementations, shown in FIG. 10, a variable write waveform line time for different lines of display elements in a display may be provided using one or more adaptive line time tables stored in a timing look-up-table (LUT) 864.

In some aspects, the line time is variable based on the image data that is to be written the display elements. For example, the line time of a particular line of display element may be a function of the number of display elements that will transition from an un-actuated state to an actuated state and the number of segment line transitions for writing the image data to the display. When writing a line of data, information about the data to be written may be used to access an entry or entries in the LUT 864 to determine the timing parameters of the waveforms to be implemented when writing that line. For example, based on a number of display elements that will be transitioned from an un-actuated state to an actuated state when writing a line of the display elements (i.e., a write actuation state), the lookup table 864 may be used to determine a particular line time for a write pulse. Other parameters that may be included in the lookup table 864 may include an overvoltage (e.g., high address voltage) that may be correlated to the required line time. In some aspects, temperature information may be used to further compensate the adaptive line time tables. For example, different tables may be used for varying temperatures that an electronic device including the panel is exposed to.

In some aspects, the adaptive line time tables may be provided on a per-panel or a per-common line basis. In some aspects, a maintenance mode of an electronic device may provide feedback to continually or periodically customize the adaptive line time tables over the life of the apparatus, similar to what is done with the V/T LUT 824 for the voltage amplitudes described above.

In some implementations, different numbers of adaptive line time lookup tables may be used. In one example, a single adaptive line time lookup table may be used for the whole panel of display elements. An appropriate adaptive line time lookup table may be determined based on the common line with the smallest overdrive voltage during write. A maintenance mode may be periodically performed over the life of the electronic device to verify the overvoltage of the common lines.

In another example, an adaptive line time lookup table may be provided for each common line in the display panel. Feedback from a maintenance mode operation may be provided in order to allow adjustments of the lookup table based on varying temperatures and voltage changes.

In another example, different adaptive line time lookup tables may be provided according to different classifications that are associated with the various common lines. A speed classification as used herein is a value or category associated with a common line that provides a measure of how short a line time can be utilized to write data to the line with acceptable errors. It may be a relative assessment, in that the speed classification value for a common line indicates how much shorter or longer a line time a line in a display array can accept relative to another, or it may be an absolute assessment, in that a particular classification indicates a minimum line time that may be used for that line with acceptable results. For example, eight adaptive line time lookup tables may be provided, with each lookup table being associated with a different classification of common lines. The classification may be determined based on the amount of overvoltage the display elements of the particular common line require to be actuated, as it has been found that display elements needing a lower voltage for actuation can also be written faster than display elements needing a higher voltage for actuation. During a factory mode calibration of the display panel, each common line may be given a “speed classification.” During the life of the electronic device, a maintenance mode operation may be performed to re-calibrate the display panel and adjust the classifications of each common line.

For example, a controller of the display may select a representative common line from the display panel. In some aspects, the controller may select a representative common line for each color of the panel. The controller may further determine an amount of overvoltage required for actuating the display elements on the representative common line. The amount of overvoltage may be compared to a previously determined amount of overvoltage that was previously required to actuate the display elements. Based on the change in overvoltage, the controller may adjust the classification assigned to one or more common lines. A controller may rotate through all of the common lines and periodically test the overvoltage of each common line on the panel over a period of time. In this example, a controller may determine an amount of overvoltage required for actuating display elements on each common line of the display panel. The controller may compare the determined amount of overvoltage to a previously determined amount of overvoltage and may adjust the classification assigned to the common line based on the comparison. During the process of writing image data, the processor may access the speed classification for the line, combine this information with the information about the data to be written, and generate line timing parameters to use when writing the data to the line.

In some implementations, wherein the display includes an array of IMODs, each line of movable mirrors of the IMODs may be given a speed classification, for example a speed classification between one and eight. This speed classification may then be used to indicate which set of adaptive line time tables should be used for each line of moveable mirrors.

FIG. 11 shows an example of a flow diagram illustrating a method of driving an array of display elements in a display. The display can include a flat-panel display, such as plasma, EL, OLED, STN LCD, or TFT LCD, etc., or an IMOD display. The method can be performed by software, hardware, or a combination thereof. The method can begin at block 1201 by storing speed classification for different portions of an array of display elements. The speed classifications may be stored in memory. The method can 1200 continue at block 1203 by writing electronic signals to the different portions of the array of display elements based at least in part on the speed classifications. The method 1200 may optionally continue at block 1205 by updating the speed classifications over the lifetime of the display.

FIGS. 12A and 12B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 12B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 13B, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus for driving a display including a plurality of common lines and a plurality of segment lines connected to an array of display elements, the apparatus comprising:
a controller configured to receive, as part of a frame of image data to be written to the array of display elements, image data for one or more common lines of the array, wherein the controller is configured to determine one or more waveform timing parameters for writing at least some of the image data to display elements along at least a first one of the one or more common lines of the array;
a memory storing information correlating different line speed classifications with different portions of the array of display elements;
wherein the determining is based at least in part on the stored speed classification of the portion of the array containing the one or more common lines and one or more of:
the write actuation state to be produced in the display elements along at least the first one of the one or more common lines as defined by the at least some of the image data, and
characteristics of at least some of the segment line transitions that will occur to place the segment lines in a series of states operable to write the image data to the one or more common lines; and
a common driver and a segment driver configured to drive the array of display elements to write the at least some of the image data to display elements along the at least first one of the one or more common lines with the determined one or more waveform timing parameters.

2. The apparatus of claim 1, wherein the controller determines one or more waveform timing parameters while the apparatus is driving the display.

3. The apparatus of claim 1, wherein the controller is further configured to access at least one lookup table stored in the memory.

4. The apparatus of claim 3, wherein a single lookup table is used for the entire array of display elements.

5. The apparatus of claim 3, wherein a different lookup table is used for each common line of the one or more common lines of the array of display elements.

6. The apparatus of claim 3, wherein the lookup table stores a speed classification for each common line of the one or more common lines of the array.

7. The apparatus of claim 6, wherein each speed classification is determined based on an amount of overvoltage applied to each common line.

8. The apparatus of claim 7, wherein the controller is further configured to:
select a representative common line from the one or more common lines of the array;
determine an amount of overvoltage for actuating one or more display elements on the representative common line;
compare the determined amount of overvoltage to a previously determined amount of overvoltage; and
adjust the speed classification assigned to a common line based at least in part on the comparison.

9. The apparatus of claim 1, further comprising:
a processor that is configured to communicate with the display, the processor being configured to process image data; and
a memory device that is configured to communicate with the processor.

10. The apparatus as recited in claim 9, further comprising:
a driver circuit configured to send at least one signal to the display.

11. The apparatus as recited in claim 10, further comprising:
a controller configured to send at least a portion of the image data to the driver circuit.

12. The apparatus as recited in claim 9, further comprising:
an image source module configured to send the image data to the processor.

13. The apparatus as recited in claim 12, wherein the image source module includes at least one of a receiver, transceiver, and transmitter.

14. The apparatus as recited in claim 9, further comprising:
an input device configured to receive input data and to communicate the input data to the processor.

15. A method of driving an array of display elements comprising:
storing speed classifications for different portions of the array of display elements in memory; and
writing electronic signals to the different portions of the array of display elements based at least in part on the speed classifications.

16. The method of claim 15, further comprising updating the stored speed classifications over the lifetime of the display.

17. The method of claim 16 wherein, updating the speed classifications comprises:
selecting a representative common line from one or more common lines of the display elements;
determining an amount of overvoltage for actuating one or more of the display elements on the representative common line; and
comparing the determined amount of overvoltage to a previously determined amount of overvoltage.

18. The method of claim 15, wherein a time period between writing a first electronic signal and a second consecutive signal is based at least in part on the stored speed classifications.

19. An apparatus for driving a display including a plurality of common lines and a plurality of segment lines connected to an array of display elements, the apparatus comprising:
a memory storing information correlating different line speed classifications to different portions of the array of display elements; and
means for writing electronic signals to the different portions of the array of display elements based at least in part on the speed classification of the portion of the array.

20. The apparatus of claim 19, wherein the means for writing electronic signals to the different portions of the array of display elements based at least in part on the speed classification of the portion of the array comprises:
a common driver and a segment driver configured to write at least some of the electronic signals to the different portions of the array of display elements based at least in part on the speed classification; and
a controller coupled to the common driver, the segment driver, and the memory, the controller configured to determine which speed classification from the memory to assign each portion of the array of display elements.

21. A non-transitory computer readable media having instructions stored thereon that cause a processing circuit to perform a method of driving an array of display elements, the method comprising:
storing speed classifications for different portions of an array of display elements in memory; and
writing electronic signals to the different portions of the array of display elements based at least in part on the speed classifications.

22. The non-transitory computer readable media of claim 21, wherein the instructions cause the processor to update the stored speed classifications over the lifetime of the display.

23. The non-transitory computer readable media of claim 22 wherein, updating the speed classifications comprises:
selecting a representative common line from one or more common lines of the display elements;
determining an amount of overvoltage for actuating one or more of the display elements on the representative common line; and
comparing the determined amount of overvoltage to a previously determined amount of overvoltage.
